(19) United States
(12) Patent Application Publication
(10) Pub. No.: US 2005/0013523 A1
(43) Pub. Date: Jan. 20, 2005

(54) Optical add drop multiplexer device

(76) Inventor: John Edward Gunther, Redondo Beach, CA (US)

Correspondence Address: JERRY RICHARD POTTS, 3248 VIA RIBERA, ESCONDIDO, CA, 92029, US

(21) Appl. No.: 10/713,723

(22) Filed: Nov. 14, 2003

Related U.S. Application Data
(60) Provisional application No. 60/426,221, filed on Nov. 14, 2002.

(51) Int. Cl. G02F 1/295

(52) U.S. Cl. 385/10

(57) ABSTRACT

An OADM device with low PDL and PMD for use in optical communications systems comprises: a through optical waveguide, a coupling circuit element and an add/drop circuit element comprising at least one of an input waveguide and an output waveguide. The coupling lightwave circuit element is optically coupled to the add/drop circuit element and the through optical waveguide by means of electrically variable gratings. Typically, the optical signal is a multi-channel WDM signal. Preferably, the variable grating is an ESBG. Each grating is overlaid by an electrode arrangement applied to a cover glass. Each electrode arrangement has first and second portions spaced from one another in the direction of light propagation, The electrodes provide electric fields that are generally orthogonal to one another and transverse to the direction of light propagation, thereby minimizing the effects of PDL and PMD. A selected channel is dropped from the optical waveguide by applying appropriate voltages to the electrode arrangement, such that the selected channel is transferred from the through optical waveguide to the coupling circuit element and from the coupling circuit element to the output waveguide of the add/drop circuit element. A selected channel is added to the optical waveguide by applying appropriate voltages to the electrode arrangement such that the selected channel is transferred from the input waveguide of the add/drop circuit element to the coupling circuit element and from the coupling circuit element to the through waveguide. The coupling circuit element may be an S-shaped coupling waveguide or a ring coupler waveguide.

### RELATED APPLICATIONS

This application claims benefit of the filing date of the U.S. Provisional Application No. 60/426,221, filed Nov. 14, 2002, entitled “Optical Add Drop Multiplexer Device with Low PDL and PMD”.

### BACKGROUND OF THE INVENTION

This invention disclosure relates to an optical device for selectively transferring wavelengths between optical communication channels. In particular, but not exclusively, the invention relates to such an optical device for use in optical telecommunications.

There is a requirement for efficient wavelength selective switching in optical networks, in particular in Dense Wavelength Division Multiplexed (DWDM) networks. Devices known as Optical Add-Drop Multiplexers (OADMs) are used to selectively remove (drop) wavelengths from a multiplicity of wavelengths in a fiber and add the same wavelength, but with a different data content. In one important class of OADM architectures, the basic wavelength selection mechanism relies on a grating assisted coupler, which uses the well-known wavelength selective properties of Bragg gratings. The Bragg grating is located such that it partially overlaps the mode fields of two adjacent waveguide sections. The waveguides, which need to be in sufficiently close proximity for evanescent coupling to occur, may be asymmetric. The gratings may be passive in operation allowing fixed wavelengths to be coupled. A much more versatile device is provided if the gratings are fabricated in electro-optical material such as Holographic Polymer Dispersed Liquid Crystal (H-PDLC). Domash [U.S. Pat. Nos. 5,937,115 and 6,567,573] discloses a range of such devices, referred to as Electrically Switchable Bragg Gratings (ESBGs). ESBGs allow the add/drop of wavelengths channels to be controlled dynamically. It is also possible to drop or add several different wavelength channels simultaneously by configuring ESBGs of different resonant wavelengths in a linear array.

An ESBG is essentially a grating with fringe planes normal to the axis of the waveguide core. This diffractive structure is equivalent to a uniaxial electro-optical material. Referring to the schematic drawing of a typical prior art ESBG device in FIG. 1 The device comprises a planar waveguide optical circuit 10 containing a waveguide core 20, a thin ESBG layer 30 and a cover glass 40 to which electrodes, which are not shown, have been applied. The cover plate, waveguide substrate, or both must have electrodes for applying an electric field across the PDLC layer in order to rotate the orientation of the LC molecules and thus change the diffraction efficiency of the Bragg grating. Typically, ESBG devices are fabricated by first placing a thin film of a mixture of photopolymerisable monomers and liquid crystal material between the waveguide and substrate. A Bragg grating is then recorded by illuminating the liquid material with two mutually coherent laser beams, which interfere to form the desired grating structure. During the recording process, the monomers polymerize and the PDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The grating exhibits very high diffraction efficiency, which may be controlled by the magnitude of the electric field applied across the PDLC layer. When an electric field is applied, the natural orientation of the LC droplets is changed causing the refractive index modulation to reduce and the hologram diffraction efficiency to drop to very low levels. U.S. Pat. No. 5,942,157 by Sutherland et al. and U.S. Pat. No. 5,751,452 by Tanaka et al. describe monomer and liquid crystal material combinations suitable for fabricating ESBG devices. A recent publication by Butler et al. (“Diffractive properties of highly birefringent volume gratings: investigation”, Journal of the Optical Society of America B, Vol. 19 No. 2, February 2002) describes analytical methods for designing ESBG devices and provides references to publications describing the fabrication and application of ESBG devices.

In general, the strength of the attenuation, reflection or transmission due to a Bragg grating, which can be in the core or in close proximity to the core, depends on the intensity of the interaction or overlap between the waveguide mode and the Bragg grating and on the strength of the grating itself. The strength of the grating is characterized by its refractive index modulation. This interaction is typically controlled by adjusting the index modulation of the grating as described in U.S. Pat. No. 5,937,115 by Domash. In U.S. Pat. No. 5,937,115 the index modulation of an ESBG is changed by switching the HPDLC birefringence. The index modulation may be understood as the contrast between the high index and low index regions in the grating.

According to well know principles of waveguide optics, the strength of interaction between the grating and a beam mode propagating in the waveguide depends on the overlap between the waveguide mode and the grating layer. When the index of the grating medium is close to but less than the index of the waveguide core, the interaction is strong and Bragg coupling occurs, ie the mode expands toward the grating and the overlap increases. When the index of the grating layer is reduced, the interaction is weaker because the waveguide mode is suppressed such that the overlap between the waveguide mode and the grating layer is small. Even though the index modulation of the grating layer may remain substantially unchanged, the grating coupling is substantially reduced.

According to the basic principles of Bragg gratings, a grating spatial frequency corresponds to a unique grating resonance wavelength. Changing the index modulation of the grating will result in wavelength-selective coupling of light from the waveguide core to forward or backward propagating modes in the ESBG. This latter property provides the basis for wide range of OADM architectures.

However, materials such as holographic PDLC are inherently birefringent and thus suffer from the problems of Polarization Dependent Loss (PDL) and Polarization Mode Dispersion (PMD). PDL is defined as the variation in device insertion loss or attenuation as a function of the polarization of the input light. PMD is similarly defined as the variation in phase shift or transit time through the device as a function of the polarization of the input light. To satisfy the requirement for low PDL and low PMD, the performance of components for use in fiber optic communications systems must be essentially independent of the polarization of the incident light. This condition is very difficult to achieve in any component incorporating an inherently birefringent material, such as a holographic polymer dispersed liquid crystal material.

Therefore it would be desirable to provide an OADM that overcomes the problem of the intrinsic birefringence of PDLC material systems required to implement ESBGs. In particular there is a requirement for an OADM that largely eliminates PDL and PMD while providing all of the optical efficiency and architectural flexibility afforded by earlier solutions based on grating assisted couplers.

### SUMMARY OF THE INVENTION

In accordance with the basic principles of the invention there is provided an OADM device with low PDL and PMD for use in optical communications systems, comprising: a through optical waveguide, an intermediate circuit element and an add/drop circuit element comprising of at least one of an input (add) waveguide and an output (drop) waveguide. The coupling lightwave circuit element is optically coupled to the add/drop circuit element and the through optical waveguide by means of electrically variable gratings. Typically, the optical signal is a multi-channel WDM signal. Preferably, the variable grating is an ESBG.

Each grating is overlaid by an electrode arrangement applied to a cover glass. The electrodes selectively apply a first and a second electric field across each grating. No signal coupling occurs when said first electric field is applied to said grating. However, a selected amount of signal coupling takes place when said second electric field is applied.

Each electrode arrangement has first and second portions spaced from one another in the direction of light propagation, The electrodes provide electric fields that are generally orthogonal to one another and transverse to the direction of light propagation, thereby minimizing the effects of PDL and PMD.

A selected channel is dropped from the through optical waveguide by applying said second electric fields to said variable gratings such that the selected channel is transferred from the through optical waveguide to the coupling circuit element and from the coupling circuit element to the output waveguide of the add/drop circuit element.

A selected channel is added to the through optical waveguide by applying said second electric fields to said variable gratings such that the selected channel is transferred from the input waveguide of the add/drop circuit element to the coupling circuit element and from the coupling circuit element to the through waveguide.

In a first embodiment of the invention the coupling circuit element is an S-shaped coupling waveguide configured with two variable gratings to perform add or drop operations.

In a second embodiment of the invention the coupling circuit element is a ring coupler waveguide configured with two variable gratings to perform add or drop operations.

In a third embodiment of the invention the coupling circuit element is a ring coupler waveguide configured with three variable gratings to perform add and drop operations.

A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1 is a schematic view of an ESBG;

FIG. 2 is a schematic view of a first practical embodiment of the invention;

FIG. 3 is a schematic view of the electrode arrangement;

FIG. 4 is a schematic view of a second practical embodiment of the invention;

FIG. 5 is a schematic view of a third practical embodiment of the invention.

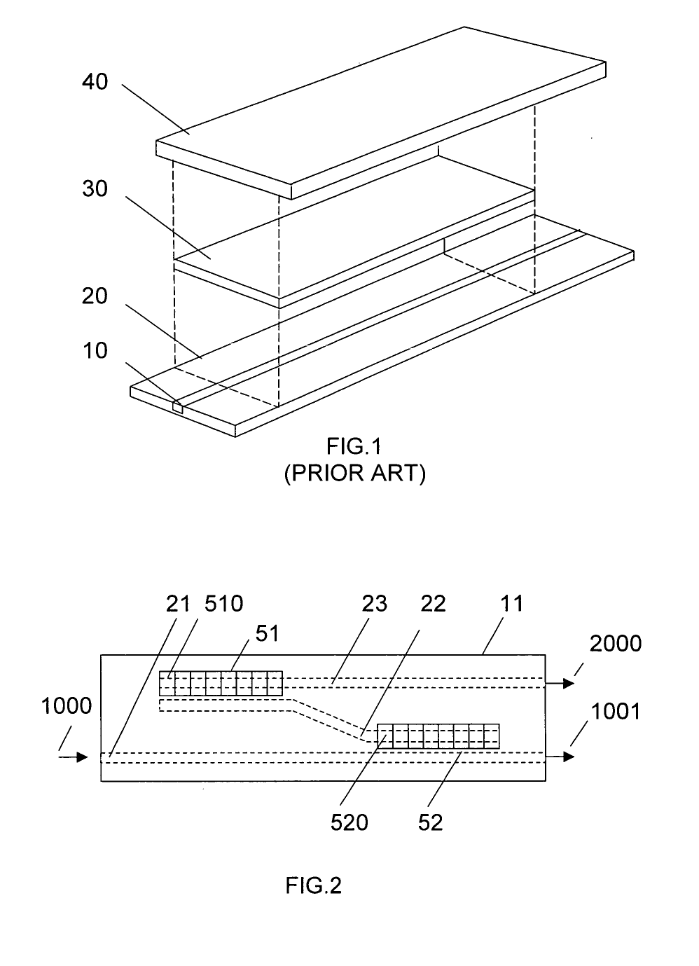

### DETAILED DESCRIPTION OF THE INVENTION

FIG. 2 shows a plan view of an electro-optical device in accordance with the present invention. The device comprises a substrate 11, a through waveguide, 21, with an input port 1000 and an output port 1001, an output (drop) waveguide 23, with an output port 2000 and an S-shaped coupling waveguide 22, containing sections parallel to the drop and through waveguides. The input to and output from the device are light signals coupled to the input and output ports 1000 and 1001 of the waveguide core. Typically, single mode optical fibers would be aligned and bonded to the ends of the core in order to couple the input and output signals. Other methods, including free space optical links using lenses may also used for this purpose.

A first ESBG 51, is overlaid on the drop waveguide and a second ESBG 52, is overlaid on the S-shaped coupling waveguide. Providing that the modal overlap requirements of grating assisted couplers are met, the gratings allow wavelengths matching the grating resonance wavelength to be added or dropped. In particular the grating 52 is operative to couple light from the through waveguide to the coupling waveguide while grating 51 is operative to couple light from the coupling waveguide to the drop waveguide.

In the embodiment shown in FIG. 2, each grating contains 8 individual switchable grating sections, of which the grating sections 510 and 520 are examples. Each grating section has a unique spatial frequency corresponding to a unique grating resonance wavelength.

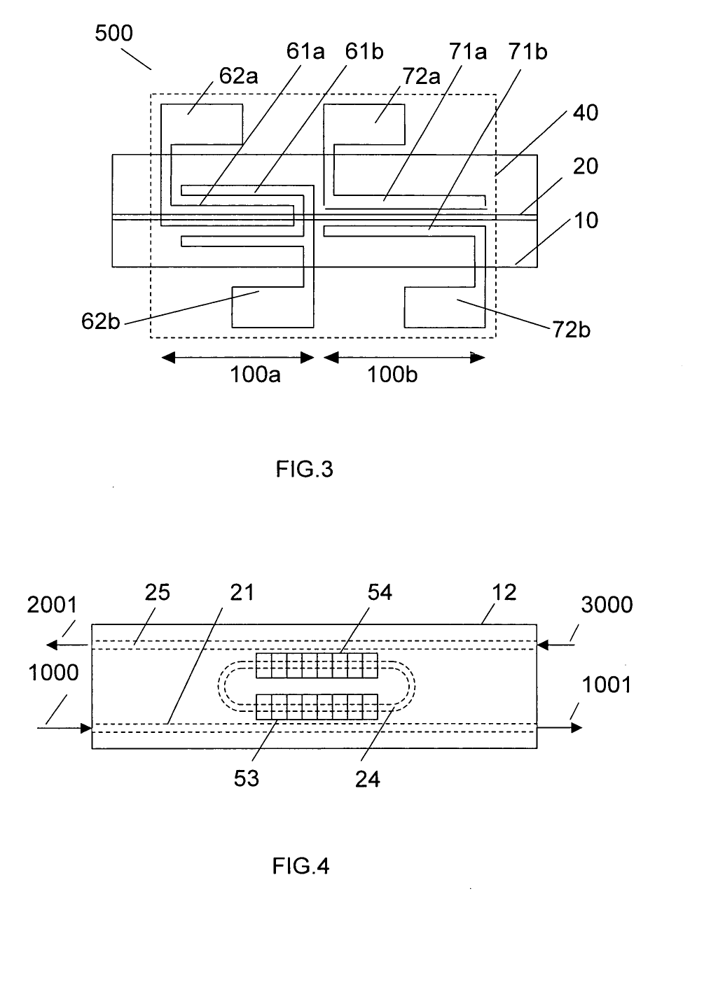

Electrodes for one grating section, such as 510 or 520, are shown in more detail in the top schematic view of FIG. 3, which shows the waveguide substrate 10 containing the waveguide core 20. The electrodes are deposited on a surface of a cover glass, which is not shown. The electrodes, generally indicated by 500, are divided into sequential Transverse Electric (TE) and Transverse Magnetic (TM) portions indicated by 100a and 100b. As shown in FIG. 3, the TE electrodes comprise the central electrode portions 61a, 61b and the pads 62a, 62b and the TM electrodes comprise the central electrode portions 71a, 71b and the pads 72a , 72b. The basic principles of sequential TE-TM electrodes have been described in our U.S. Provisional Filling No. 60/309,153, filed 31 Jul. 2001, entitled “Electro-Optical Device with Sequential Sections for Orthogonal Polarization Modes”, since filed as a PCT application PCT/BG02/03530 and published as WO 03/012532 A2 on 13 Feb. 2003.

Voltages from an external source (not shown) are applied to the pads, which create electric fields across the ESBG layer. With respect to the electrode portion 100b, as shown in FIG. 3, the electrode creates an electric field parallel to the surface of the waveguide substrate and normal to the axis of the waveguide. Since the extraordinary axis of the ESBG rotates in the direction of the electric field vector, the grating index modulation is changed such that the grating interacts with a portion of the mode field of TE polarized light propagating in the waveguide core. With respect to the electrode portion 100a, the electrodes create an electric field orthogonal to the surface of the waveguide substrate, which causes the ESBG to interact with the TM mode. Here TE polarized light is defined as that component of the light propagating in the waveguide core having the electric field vector parallel to the surface of the substrate. TM polarized light is defined as that component of the light propagating in the waveguide core having the electric field vector orthogonal to the surface of the substrate.

Thus the sequential TE TM electrode structure provides for light having orthogonal polarization modes to be coupled between the through waveguide and the coupling waveguide, and from the coupling waveguide to the drop waveguide. Since a different voltage can be applied to the TE and TM electrode, the coupling efficiency for the two orthogonal polarization states can be made to be the same. Thus the coupling will not introduce PDL.

It will be clear from consideration of the embodiment of FIG. 2 in conjunction with FIG. 3 that the coupling from the through waveguide to the coupling waveguide will have PMD, since the coupling of the TE and TM polarization states will occur at different physical locations along the waveguides. However, by reversing the order of the TE and TM electrodes sections on the two ESBGs, the net optical path length can be made the same for TE and TM, thus effectively eliminating the PMD between the through waveguide and the drop waveguide.

It will also be clear from inspection of FIG. 2 that if the inputs and outputs are reversed the same basic architecture can be used to perform an “Add” function.

FIG. 4 shows a schematic plan view of a further embodiment of the invention, which uses a ring coupler to perform the function of the coupling waveguide. The device comprises a planar optical waveguide circuit 12, a through waveguide 21, with an input port 1000 and an output port 1001, a add-drop waveguide 25, with an input port 3000 and an output port 2001. The ring coupler 24 contains sections parallel to the add-drop and through waveguides. The ring coupler is configured with one ESBG 53 in the arm adjacent to the add-drop waveguide and one ESBG 54 in arm adjacent to the through waveguide. As in the case of the embodiment shown in FIG. 3, the order of the TE and TM electrodes sections on the ESBGs 53 and 54 can be reversed in order to equalize the net optical path lengths for TE and TM, thus effectively eliminating PMD. The input to and output from the device are light signals coupled to the input and output ports 1000 and 1001.

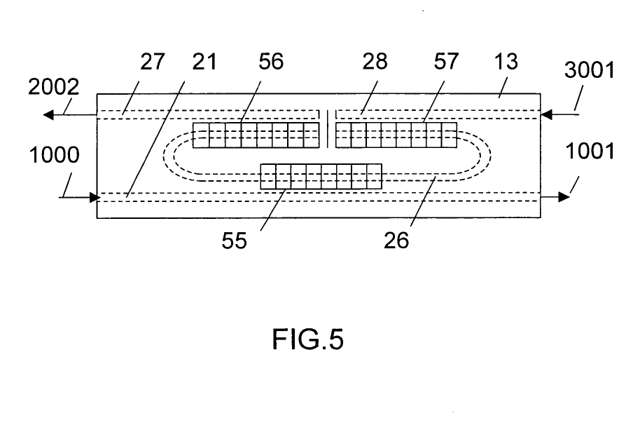

FIG. 5 shows a schematic plan view of a yet further embodiment of the invention, which uses separate couplers to perform the function of the coupling waveguide. In contrast to the embodiment of FIG. 4, this embodiment requires the addition of a third grating and set of electrodes. The device comprises a planar optical waveguide circuit 13, a through waveguide 21 with an input port 1000 and an output port 1001, an add waveguide 28, a drop waveguide 27 with input and output ports 3001 and 2002 respectively and a ring coupler waveguide 26. The ring coupler containing sections parallel to the add and drop waveguides and the through waveguides. The ring coupler is configured with one ESBG 55 in the arm adjacent to the through waveguide, one ESBG 56 in the arm adjacent to the drop waveguide and ESBG 74 in the arm adjacent to the drop waveguide. With reference to the drop channel, the order of the TE and TM electrodes sections on the ESBGs 55 and 56 can be reversed in order to equalize the net optical path lengths for TE and TM, thus effectively eliminating PMD in the drop channel. The input to and output from the device are light signals coupled to the ends of the waveguide core 1000 and 1001. Similarly the order of the TE and TM electrodes sections on the ESBGs 55 and 57 can be reversed to effectively eliminate PMD in the add channel.

Whereas the invention has been described in relation to what are presently considered to be the most practical and preferred embodiments, it will be apparent to those skilled in the art that the invention is not limited to the disclosed arrangements but rather is intended to cover various modifications and equivalent construction included within the spirit and scope of the invention.

1. An optical component for selectively reconfiguring a guided wave optical signal, comprising:
an optical waveguide having an input port for receiving light and an output port for outputting reconfigured light;
a first lightwave circuit element optically coupled to said optical waveguide by means of a first electrically variable grating;
a first electrode arrangement overlaying said first electrically variable grating;
a second lightwave circuit element optically coupled to said first lightwave circuit element by means of a second electrically variable grating;
a second electrode arrangement overlaying said second electrically variable grating;
wherein each of said first and second electrode arrangements have a first portion adapted to form a first electric field in response to first applied voltage and a second portion adapted to form a second electric field in response to a second applied voltage, said first and second electrode portions are spaced from one another in the direction of light propagation, and wherein said first and second electric fields are generally orthogonal to one another and transverse to the direction of light propagation.

2. The optical component of claim 1, wherein:
said optical signal is a multi-channel WDM signal;
at least one selected channel is transferred between said optical waveguide and said first lightwave circuit element when said first voltage and said second voltage are applied to said first electrode arrangement; and
said at least one selected channel is transferred between said first lightwave circuit element and said second lightwave circuit element when said first voltage and said second voltage are applied to said second electrode arrangement.

3. A component as claimed in claim 1, wherein said variable grating is an ESBG.

4. A component as claimed in claim 1, wherein said first lightwave circuit element is a ring coupler waveguide.

5. A component as claimed in claim 1, wherein said first lightwave circuit element is an S-shaped coupling waveguide.

6. A component as claimed in claim 1, wherein the order of said first and second electrode portions of said second electrode arrangement is reversed with respect to said first and second portions of said first electrode arrangement.

7. A component as claimed in claim 1, wherein said first and second variable gratings each comprise a multiplicity of individually switchable grating sections, each said grating section having a unique spatial frequency corresponding to a unique grating resonance wavelength, and wherein each grating section is overlayed by an independent electrode arrangement.

8. A component as claimed in claim 1, wherein said component functions as an optical add drop multiplexer

9. The optical component of claim 1, further comprising:
a third lightwave circuit element optically coupled to said first lightwave circuit element by means of a third electrically variable grating;
a third electrode arrangement overlaying said third electrically variable grating;
wherein said third electrode arrangement has a first portion adapted to form a first electric field in response to first applied voltage and a second portion adapted to form a second electric field in response to a second applied voltage, said first and second electrode portions spaced from one another in the direction of light propagation, and wherein said first and second electric fields are generally orthogonal to one another and transverse to the direction of light propagation.

10. The optical component of claim 9, wherein:
said optical signal is a multi-channel WDM signal;
at least one selected channel is transferred from said optical waveguide to said second lightwave circuit element when said first voltage and said second voltage are applied to said first and second electrode arrangements; and
said at least one selected channel is transferred between said third lightwave circuit element and said optical waveguide when said first voltage and said second voltage are applied to said first and third electrode arrangements.

11. A component as claimed in claim 9, wherein said first lightwave circuit element is a ring coupler waveguide.

12. A component as claimed in claim 9, wherein the order of said first and second electrode portions of said second and third electrode arrangement is reversed with respect to said first and second portions of said first electrode arrangement.

13. A component as claimed in claim 9, wherein said first, second, and third variable gratings each comprise a multiplicity of individually switchable grating sections, each said grating section having a unique spatial frequency corresponding to a unique grating resonance wavelength, and wherein each grating section is overlayed by an independent electrode arrangement.

14. A component as claimed in claim 9, wherein said component functions as an optical add drop multiplexer
